(19) United States
(12) Patent Application Publication
(10) Pub. No.: US 2022/0385150 A1
(43) Pub. Date: Dec. 1, 2022

(54) METHOD FOR SHAPING A CONDUCTOR PIECE ARRANGED IN A STATOR CORE AND CORRESPONDING DEVICE AND THE USE OF SAME

(71) Applicant: Gehring Technologies GmbH + Co. KG, Ostfildern (DE)

(72) Inventor: Christoph Bäder, Altbach (DE)

(73) Assignee: Gehring Technologies GmbH + Co. KG, Ostfildern (DE)

(21) Appl. No.: 17/776,115

(22) PCT Filed: Nov. 12, 2020
(86) PCT No.: PCT/EP2020/081880

§ 371 Date: May 11, 2022

(30) Foreign Application Priority Data
Nov. 12, 2019 (DE) 10 2019 130 535.7

(51) Int. Cl. H02K 15/00; B21F 3/02

(52) U.S. Cl. CPC H02K 15/0037; B21F 3/02

(57) ABSTRACT

The invention relates to an apparatus and a method for shaping one or more conductor pieces arranged in a stator core, wherein the conductor piece is a hairpin with two elongate legs and a connection portion connecting these two legs, wherein a large number of conductor pieces is arranged in the stator core, which conductor pieces are arranged in rows extending in a radial direction on a plurality of circular paths extending in a circumferential direction, and wherein the shaping takes place in a free end of the conductor piece that projects from the stator core.

The invention relates to an apparatus for shaping a conductor piece arranged in a stator core, and to the use thereof and a corresponding method.

In what is referred to as hairpin technology, in the broadest sense, hairpin-shaped conductor pieces (hairpins) are used together with individual different special pins in a stator core. In this case, hairpins are conductor pieces which substantially have two elongate legs and a connection portion connecting these two legs. The large number of conductor pieces is usually arranged such that the conductor pieces are arranged in rows, which each extend in a radial direction, on a plurality of circular paths extending in a circumferential direction. The free ends of the legs project from the stator core on one side thereof and the connection portions are arranged on the other side of the stator core.

After insertion, the free ends are turned or bent in the circumferential direction, this step also being referred to as “twisting.” In this case, individual hairpins (generally conductor pieces or the free ends thereof) are twisted clockwise and others are twisted counterclockwise in the circumferential direction. Typically, the hairpins are twisted such that, after twisting, they are arranged in a directly adjacent row or in a row following the adjacent row (it is also conceivable that further rows are skipped). The twisting is carried out, for example, by means of cylinders which are arranged concentrically to one another and are rotatable, with conductor pieces which are arranged on a circular path being received in corresponding receptacles in a cylinder. Twisting the cylinders relative to one another bends the conductor pieces on adjacent circular paths in different directions.

Before twisting, it may be desirable to bend the hairpins radially outward. The present invention relates to this shaping step and provides an apparatus, the use thereof and a method for the corresponding shaping, in particular of the radially outer hairpins.

After twisting, the hairpins are usually cut to length (shortened to a specified length), and certain hairpins/conductor pieces or the free ends thereof are then welded together in order to form the windings of the stator. In order to shorten the hairpins and mask them for the welding process (this prevents hot material from entering the stator), a plate-like cover having recesses is often placed over the free ends, such that the free ends are arranged in the recesses. When cutting to length, the free ends protruding beyond the cover are then cut off by means of a plane. Other ways of cutting the hairpins to length can be provided.

The problem addressed by the present invention is that of providing an apparatus, the use thereof and a method, by means of which the shaping of conductor pieces in a stator core prior to twisting can be carried out as quickly and precisely as possible.

This problem is solved by an apparatus for shaping one or more conductor pieces arranged in a stator core, in particular hairpins according to claim 1, the apparatus comprising:

a receptacle for receiving a stator core. A large number of conductor pieces are arranged in the stator core. These conductor pieces are typically arranged in rows in a circumferential direction. Each row extends in a radial direction. The stator core is located in the receptacle in a processing position. In this case the conductor pieces to be shaped are located in an initial configuration. In the initial configuration, i.e. before the shaping, the conductor pieces project from the stator core in a longitudinal direction. The shaping in this case takes place at the free ends of the conductor pieces that project from the stator core.

In particular, the conductor pieces have a rectangular conductor cross section, it being possible for the corners of the cross section to be rounded. Furthermore, the conductor pieces typically have electrical insulation.

The apparatus further comprises a shaping unit which comprises a gripper. This gripper is designed to releasably grip the conductor pieces to be shaped (or the conductor piece to be shaped in the relevant shaping process) between at least two clamping elements in a clamping manner.

The gripper can be moved along a gripper longitudinal direction relative to the receptacle or the stator received therein (or toward and away from the receptacle or the stator received therein). In an initial state of the gripper (at the start of the shaping process), the gripper longitudinal direction extends in parallel with the longitudinal direction. The gripper can be pivoted relative to the receptacle or the stator received therein within a plane spanned by the longitudinal direction and the radial direction. In the pivoted state, the gripper longitudinal direction is inclined relative to the longitudinal direction.

The apparatus can comprise a counter-bearing device. This counter-bearing device can be placed against a conductor piece with a counter-bearing portion. A first bending point is defined by the placement of the counter-bearing portion.

However, the first bending point can also be defined by an edge which is formed by the stator core itself or by the side of the stator core that faces the free ends of the conductor pieces, such that the first bending point is located in a region of the conductor piece that is directly adjacent to the stator core. The edge can be rounded, for example to prevent damage to the conductor piece and/or the insulation of the conductor piece. It is also conceivable to use an insert, e.g. a plastic insert, in the stator and/or a mask, e.g. a plastic mask, to be placed on the stator to produce the edge which defines the first bending point.

The shaping unit can also comprise a holder. The holder is used to attach the gripper. Other elements can also be arranged on and/or fastened to the holder.

The shaping unit can have an actuator. This actuator is preferably designed as a pressure, hydraulic or pneumatic cylinder. However, an actuator based on a different principle, such as electric, magnetic, electromechanical, etc., is also conceivable. The actuator can move the gripper in a translational manner in the gripper longitudinal direction in a movement mode. The actuator can be switched into a fixed mode by fixing the gripper along the gripper longitudinal direction, such that the gripper cannot move in a translational manner along the gripper longitudinal direction. However, the actuator can also be switched into a release mode in which the gripper can be freely moved in a translational manner along the gripper longitudinal direction. In other words, the gripper can be effectively mechanically uncoupled from the actuator, such that the gripper can move freely along the gripper longitudinal direction and the actuator does not intervene in this translational movement process of the gripper (e.g. a pressure cylinder can be depressurized, such that a corresponding piston can move freely in a corresponding cylinder). The actuator can be fastened to the holder. In particular, it is possible for the actuator to be able to move the gripper relative to the holder (relative movement between the gripper and the holder). Typically, the gripper is pivotably connected to the actuator.

Furthermore, the shaping unit can comprise two pivoting devices. Each of the two pivoting devices is arranged and designed such that the gripper and/or the holder can each be pivoted on a circular path about a relevant pivot point. In this case, at least one pivoting device can be provided for pivoting the holder. Due to the fact that the gripper is arranged on the holder, the gripper is also pivoted when the holder is pivoted. Such a pivoting device therefore does not have to be fastened directly to the gripper, but is fastened to the holder. Corresponding fastening means for fastening the pivoting device to the gripper are thus unnecessary. This leads to a more compact design of the gripper.

In particular, the shaping unit can comprise a first pivoting device which is arranged and designed to pivot the gripper or the holder on a circular path about a pivot point. In particular, it is possible for the first pivoting device to be able to pivot the holder and the gripper together. For this purpose, the first pivoting device can be articulated on the holder and the holder can be pivotable together with the gripper arranged thereon by means of the first pivoting device.

In particular, the shaping unit can comprise a second pivoting device which is arranged and designed to pivot the gripper on a circular path about a second pivot point. In particular, it is possible for the second pivoting device to be able to cause a relative movement between the holder and the gripper. For this purpose, the second pivoting device can be articulated on the holder and on the gripper and can pivot the gripper relative to the holder. The second pivot point of the gripper can be an articulation point on the gripper of the actuator for moving the gripper along the gripper longitudinal direction.

The first pivoting device can be designed as a linear actuator. The first pivoting device can be pivotably articulated on the shaping unit or the holder thereof with one end of the linear actuator and articulated on the apparatus with another end of the linear actuator outside the shaping unit, such that said first pivoting device can pivot the shaping unit or the holder thereof.

For this purpose, the shaping unit or the holder thereof is typically pivotably fastened in the apparatus. It is in particular pivotably fastened to a base on which the receptacle is also arranged.

The second pivoting device can be designed as a linear actuator. The gripper can be pivotably mounted in the shaping unit or on the holder. The second pivoting device can be articulated on the holder and the gripper, such that it can pivot the gripper relative to the holder.

The actuator and at least one pivoting device, in particular the two (the first and the second) pivoting devices, can be arranged substantially in one plane. Such an arrangement leads to a compact and in particular narrow design of the shaping unit. In particular, a plurality of shaping units can be arranged radially around a stator core in a space-saving manner.

The clamping elements can be moved relative to one another, in particular in a clamping direction which is orthogonal to the gripper longitudinal direction. The clamping process is carried out as a result. The clamping elements can be moved, for example, by means of an actuator which is attached to the gripper or to the holder.

The clamping elements can be designed as clamping jaws which extend longitudinally along the gripper longitudinal direction. Two or more clamping jaws may be provided.

Furthermore, the counter-bearing device can have a counter-bearing portion which is placed against the conductor piece and thus defines a first bending point. The counter-bearing device in this case performs a radially inward movement relative to the stator. For this purpose, the apparatus can have a corresponding mounting of the counter-bearing device.

The counter-bearing portion is preferably formed so as to be arranged such that this region of the conductor piece that is directly adjacent to the stator core can be placed against this conductor piece.

It is thus possible for the free end of the conductor piece that projects from the stator core to be bent in the immediate vicinity of the stator core. As a result, a twisted region of the conductor pieces that is more compact, in particular in the longitudinal direction, can be achieved, and thus an overall more compact design of the stator is possible.

The counter-bearing portion is in particular designed to be rounded at least in part. The rounded shape of the counter-bearing portion prevents damage to the conductor piece and/or the insulation of the conductor piece. Furthermore, the bend can be geometrically defined by the size of the counter-bearing portion. The radius of the bend corresponds to the radius of the rounded shape of the counter-bearing portion and can thus be varied in a targeted manner using the size of the rounded shape of the counter-bearing portion.

The problem mentioned at the outset is also solved by the claimed method for shaping one or more conductor pieces arranged in a stator core, in particular hairpins, according to claim 10, the method comprising the following steps:

Moving a gripper along a longitudinal direction into a gripping position and gripping the conductor piece in a clamping manner by means of the gripper. The free ends of the conductor pieces arranged in the stator core that project from the stator core extend along the longitudinal direction.

In particular placing a counter-bearing portion against the conductor piece in order to define a first bending point. However, the first bending point can also be provided, for example, by the stator core itself or the edge thereof that is adjacent to the conductor piece.

Pivoting the gripper on a circular path about a first pivot point. The first pivot point of the gripper also corresponds to the first bending point. Since the gripper also pivots the gripped conductor piece when pivoting, said conductor piece is bent around the first pivot point/bending point. The first pivot point of the gripper or bending point lies in the conductor piece or directly on the conductor piece.

In particular, the pivoting movement of the gripper on the circular path takes place by pivoting the gripper about a pivot point of the holder. This pivot point of the holder is outside the conductor piece. A translational movement of the gripper relative to the holder is superimposed on the pivoting of the holder (the gripper is mounted in a guided manner relative to the holder, such that the gripper can be moved with a degree of translational freedom relative to the holder, an actuator optionally being switched into a release mode for this purpose in order to allow movement). The translational movement of the gripper results from the gripping of the conductor piece and the free translational mobility of the gripper relative to the holder during the pivoting process of the holder. In other words, the gripping of the conductor piece sets a fixed radius with which the gripper is pivoted about the first bending point. Since the first bending point/pivot point of the gripper does not coincide with the pivot point of the pivot point, this superimposition of the movements results. The first bending point and the pivot point of the holder are spaced apart from one another.

After the conductor piece has been bent around the first bending point by pivoting with the gripper, the clamping grip of the gripper can be released and the gripper can be moved along the extension of the conductor piece in the direction of the first bending point, in order to grip the conductor piece again, for example at a different point.

Pivoting the gripper about a second pivot point. This second pivot point of the gripper is arranged at a distance from the conductor piece. In this case, a second bending of the conductor piece about a second bending point is effected. The second bending point is defined by an edge of the gripper. This second bending point typically lies between the free end and the first bending point.

The relative position between the gripper and the holder of the gripper in particular changes during the second pivoting process as a result of the gripper pivoting relative to the holder.

In this second pivoting process, the gripper can be pivoted by pivoting the gripper relative to the holder.

The second pivot point of the gripper can in particular be an articulation point of an actuator which is arranged and designed to move the gripper in a translational manner relative to the holder. In particular, this actuator can have been switched into a release mode in the first pivoting process and switched into a fixed mode in the second pivoting process.

In the case of pivoting about the second pivot point of the gripper, the second bending point is preferably moved relative to the stator core. The second bending point in particular moves radially outward and along the longitudinal direction towards the stator core. The second bending point and the second pivot point of the gripper are spaced apart from one another.

The conductor piece which is to be shaped or is shaped can be the radially outermost of the conductor pieces of a row of conductor pieces extending in the radial direction. However, it is also conceivable for this conductor piece to be the innermost of the conductor pieces of a row of conductor pieces extending in the radial direction.

The first bending point, the second bending point and the second pivot point of the gripper preferably lie in one plane. This plane is preferably spanned by the longitudinal direction and radial direction.

The first and the second bend more preferably extend in one plane. Since the conductor piece has only straight portions between the two bends in the conductor piece, the entire region of the conductor piece that projects from the stator is arranged in this plane. This plane is preferably also spanned by the longitudinal direction and radial direction.

The first and/or second bend may be bent at a greater angle than is desired. Springback of the conductor piece after bending can be at least partially compensated for by means of a targeted overbending of this kind. Springback is inevitably caused by various conditions. These are, for example, the material of the conductor piece (usually copper), the thickness of the conductor piece, the temperature, etc.

It is therefore possible to bend and thus expand the individual conductor pieces such that the end of the conductor piece that faces away from the connection portion is again aligned in parallel with the longitudinal direction after being bent twice.

The problem is further solved by the use, according to claim 17, of an apparatus according to any of claims 1-10 for carrying out a method according to any of claims 11-16, the use comprising:

a first pivoting movement being carried out by a first pivoting device, and a second pivoting movement being carried out by a second pivoting device.

An actuator is provided which can move the gripper in a translational manner along the gripper longitudinal direction. During the first pivoting movement, the actuator is switched into a release mode. In this case, the gripper can be freely moved in a translational manner relative to the holder, but cannot be pivoted relative to the holder. The gripper can therefore be moved along the gripper longitudinal direction.

During the second pivoting movement, the actuator is switched into a fixed mode. In this case, the gripper or the articulation point of the actuator on the gripper is translationally fixed relative to the holder. A relative movement between the gripper and the holder takes place as a result of the gripper pivoting relative to the holder around the articulation point of the actuator.

Further features, details and advantages of the invention can be found in the wording of the claims and in the following description of the embodiments with reference to the drawings, in which:

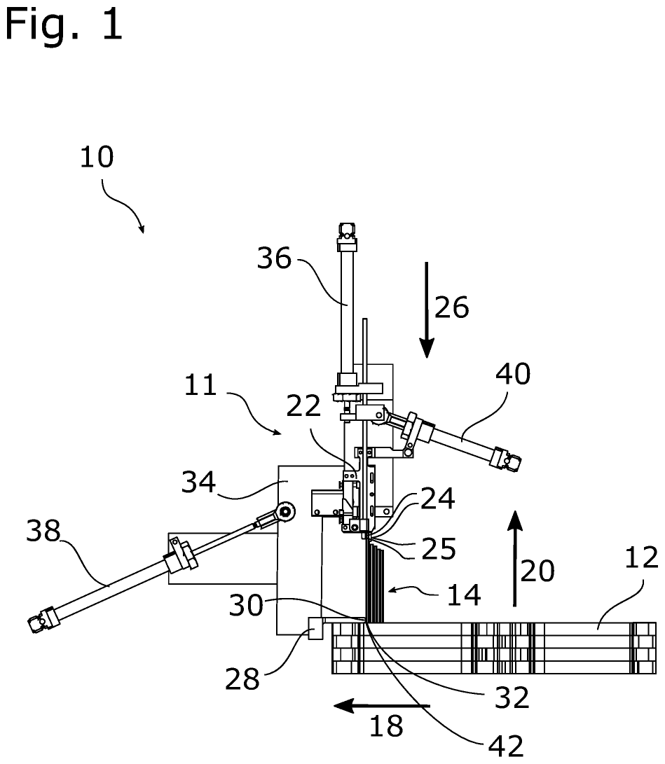

FIG. 1 is a side view of a shaping unit and a counter-bearing device of an apparatus according to the invention in an initial state;

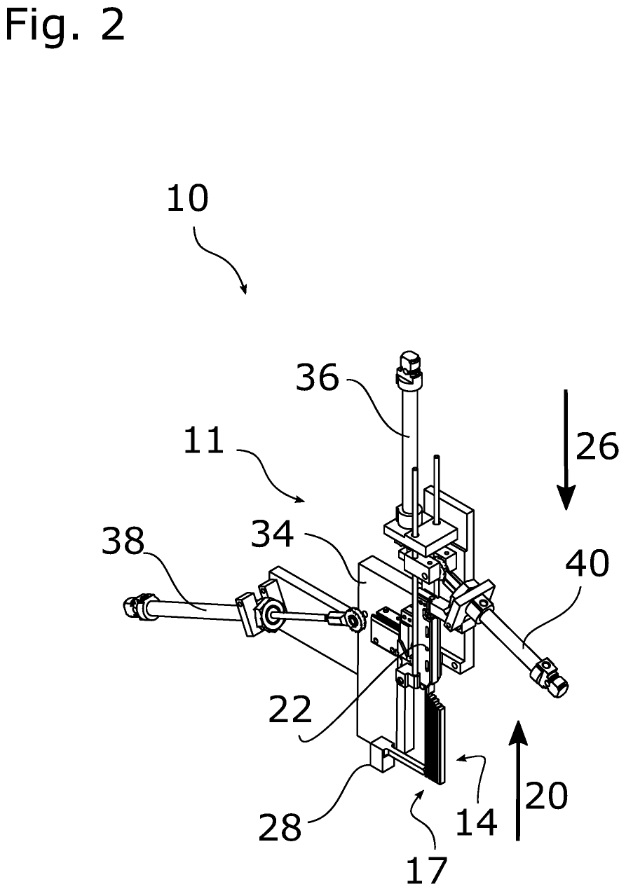

FIG. 2 is a perspective view of the shaping unit and the counter-bearing device of the apparatus according to the invention according to FIG. 1;

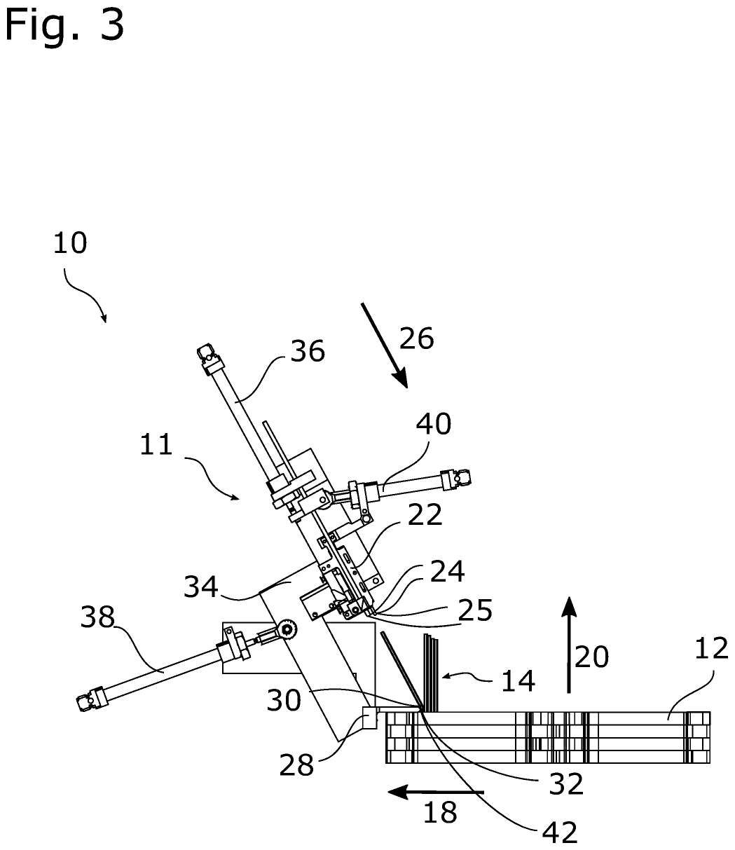

FIG. 3 is a side view of the shaping unit and the counter-bearing device of the apparatus according to the invention according to FIG. 1 in a pivoted state;

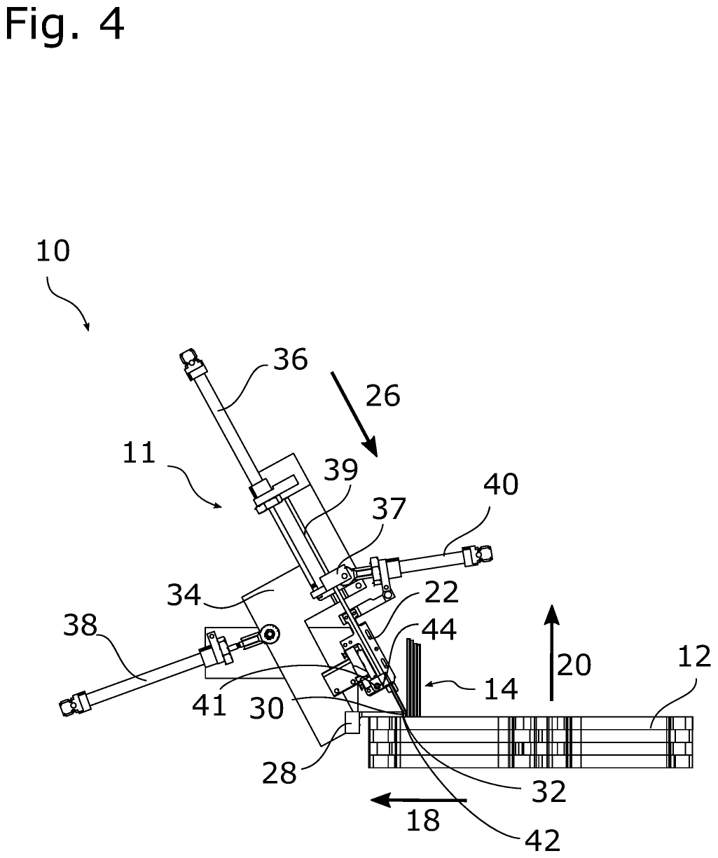

FIG. 4 is a side view of the shaping unit and the counter-bearing device of the apparatus according to the invention according to FIG. 1 in a further pivoted state;

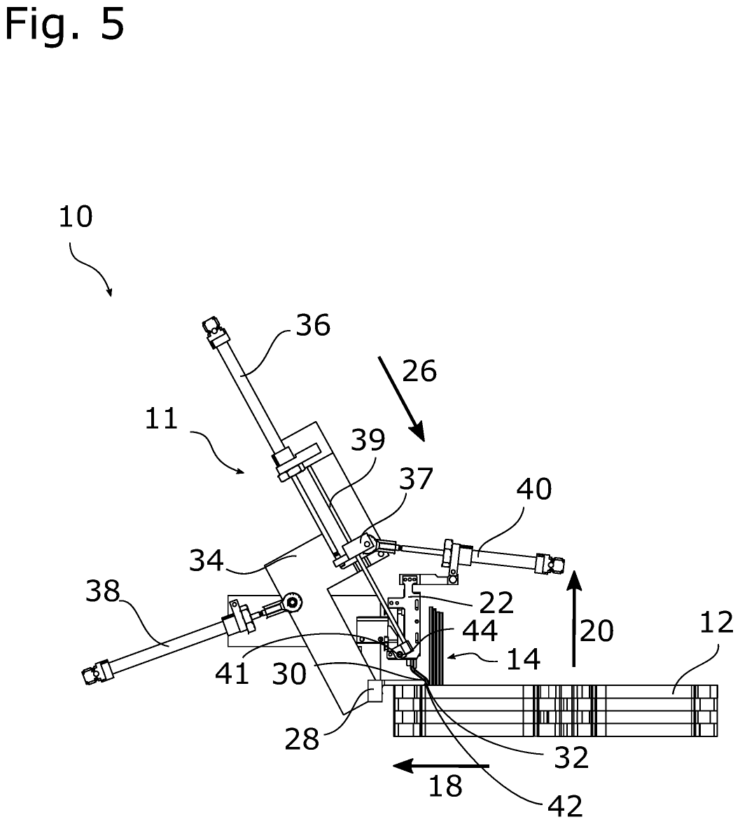

FIG. 5 is a side view of the shaping unit and the counter-bearing device of the apparatus according to the invention according to FIG. 1 in a further pivoted state;

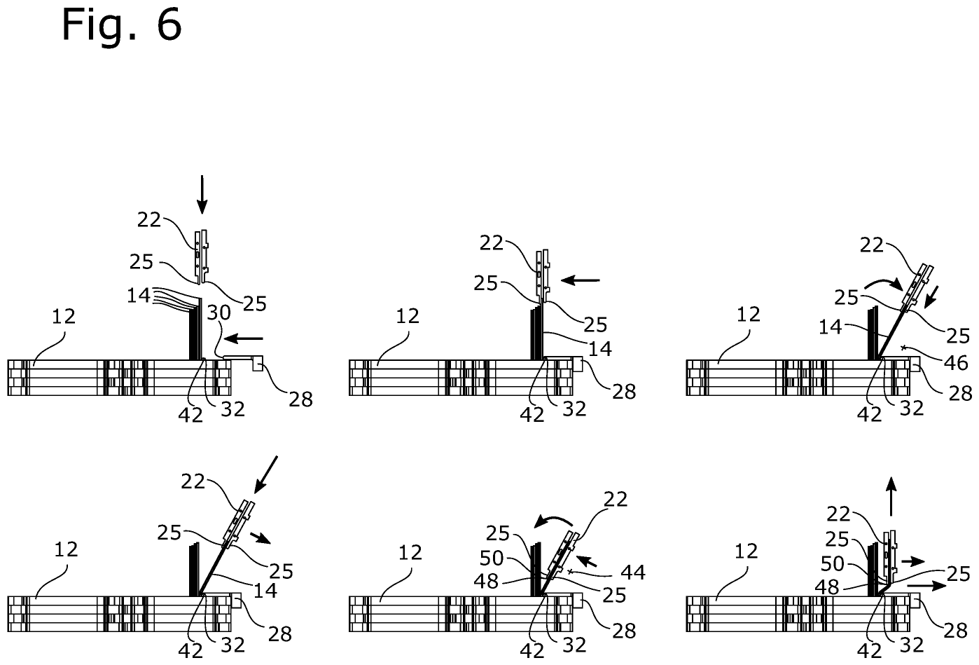

FIG. 6 shows a method according to the invention using six images; and

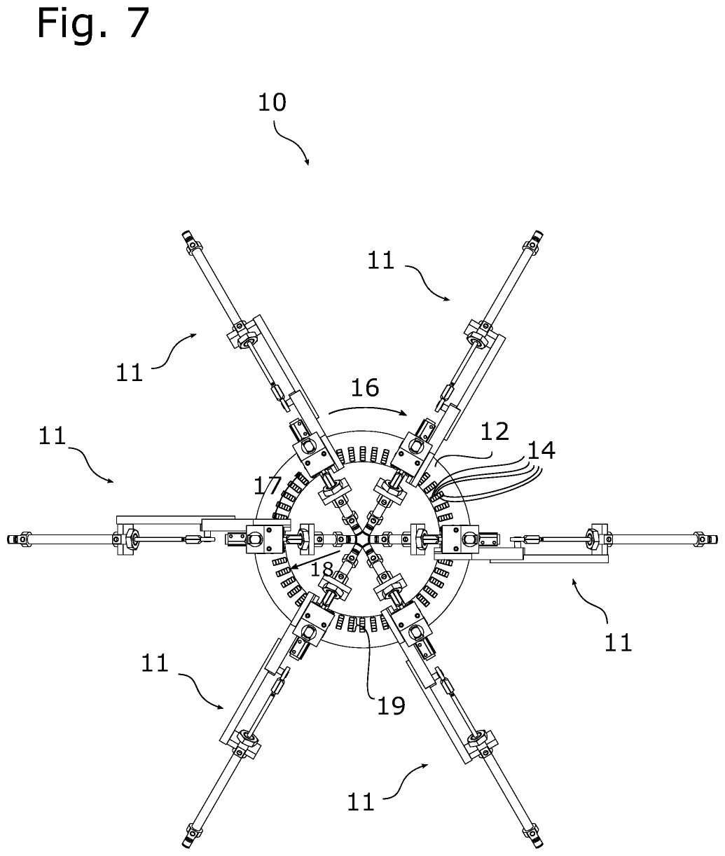

FIG. 7 is a plan view of a further apparatus according to the invention having a plurality of shaping units according to FIG. 1.

In the following description and in the drawings, corresponding components and elements have the same reference signs. For the sake of clarity, not all of the reference signs are shown in all of the figures.

FIG. 1 is a side view of a shaping unit 11 and a counter-bearing device 28 of an apparatus 10 according to the invention in an initial state, and FIG. 2 is a perspective view of the shaping unit 11 and the counter-bearing device 28 of the apparatus 10 according to the invention according to FIG. 1.

A stator core 12 and conductor pieces 14 arranged therein are partially shown in FIG. 1. The conductor pieces 14 are arranged in rows 19 in circular paths 17 which extend in a circumferential direction 16. The rows 19 extend in a radial direction 18. The conductor pieces 14 are predominantly so-called hairpins, which have two elongate legs which are in turn connected to one another via a connection portion. The conductor pieces 14 project from the stator core 12 along a longitudinal direction 20. The figures each show the free legs of the conductor pieces 14, i.e. the elongate ends of the conductor pieces 14 that face away from the connection portion connecting the legs. For the sake of clarity, only one of the rows 19 is shown in FIG. 1-6.

The shaping unit 11 has a gripper 22 which has at least two clamping elements 24. In this embodiment, these clamping elements are designed as two elongate clamping jaws 25 which can be moved relative to one another, such that a conductor piece 14 can be gripped by means of clamping. The gripper 22 can be moved along a gripper longitudinal direction 26 by means of an actuator 36. In the initial position shown here, the gripper longitudinal direction 26 and the longitudinal direction 20 are parallel to one another.

The actuator 36 can be switched into a release mode. If the actuator 36 is switched into the release mode, the gripper 22 can be freely moved along the gripper longitudinal direction 26. In this mode, the gripper 22 and the actuator 36 are effectively uncoupled from one another. The actuator 36 only guides the movement of the gripper 22; it does not cause said movement and also offers no resistance or only negligible resistance thereto.

In this embodiment, the gripper 22 and the actuator 36 are arranged on a holder 34. In the present case, the holder 34 can be pivoted by means of a first pivoting device 38. Since the gripper 22 is arranged on the holder 34 in the present case, when the holder 34 is pivoted the gripper 22 is always pivoted therewith. The gripper 22 is thus also pivoted by means of the first pivoting device 38.

The gripper 22 can be pivoted relative to the holder 34 by means of a second pivoting device 40. When the gripper 22 is pivoted by means of the second pivoting device 40, the relative position between the gripper 22 and the holder 34 is changed by pivoting the gripper 22. For this purpose, the actuator 36 is switched into a fixed mode, such that the relative position of the gripper 22 with respect to the holder 34 is fixed along the gripper longitudinal direction 26.

In this embodiment, the actuator 36 and the two pivoting devices 38, 40 are arranged substantially in the same plane. The translational and pivoting movements are also in this plane. This leads to a compact and in particular narrow design of the shaping unit 11.

The apparatus 10 also comprises a counter-bearing device 28. The counter-bearing device 28 has a counter-bearing portion 30. The counter-bearing device 28 is movable or arranged and mounted in the apparatus 10 such that it can be placed with the counter-bearing portion 30 against the outermost conductor piece 14 in the row 19 of conductor pieces 14 extending in the radial direction 18. A first bending point 32 is defined by the placement of the counter-bearing portion 30 against the conductor piece 14. The first bending point 32 is also a first pivot point 42 of the gripper 22.

FIG. 3 is a side view of the shaping unit 11 and the counter-bearing device 28 of the apparatus 10 according to the invention according to FIG. 1 in a pivoted state. The holder 34 has been pivoted by means of the first pivoting device 38 (the linear actuator of the first pivot device 38 was retracted or shortened). The gripper 22 has also been pivoted because it is arranged on the holder 34, such that the gripper longitudinal direction 26 is inclined relative to the longitudinal direction 20. In the present case, the radially outermost conductor piece 14 is already shown bent around the first bending point 32.

FIG. 4 is a side view of the shaping unit 11 and the counter-bearing device 28 of the apparatus 10 according to the invention according to FIG. 1 in a further pivoted state. The difference compared to the state of the apparatus 10 shown in FIG. 3 is that the position of the gripper 22 has been shifted by means of the actuator 36 along the gripper longitudinal direction 26 towards the first bending point 32 (the actuator 36, which is in the form of a pressure cylinder in the present case, has been extended). In the embodiment shown, the second pivoting device 40 is also shifted in a translational manner in parallel with the gripper longitudinal direction 26 by means of actuator 36, in addition to the gripper 22. The actuator 36 is connected to a translationally movable element 37 on which the second pivoting device 40 acts, or the pressure cylinder of which is pivotably articulated. This element 37 has an extension 39 which is in turn pivotably connected to the gripper 22 at an articulation point 41. This articulation point 41 of the extension 39 on the gripper 22 forms the second pivot point 44 of the gripper 22, i.e. the point about which the second pivoting device 40 pivots the gripper 22. In addition to the translationally movable element 37, the second pivoting device 40 also acts on the gripper 22. The pressure cylinder of the second pivoting device 40 is pivotably articulated on the gripper 22.

FIG. 5 is a side view of the shaping unit 11 and the counter-bearing unit 28 of the apparatus 10 according to the invention according to FIG. 1 in a further pivoted state. The difference compared to the state of the apparatus 10 shown in FIG. 4 is that the gripper 22 has been pivoted by means of the second pivoting device 40. The relative distance between the gripper 22 or the articulation point 41 of the actuator 36 on the gripper 22 and the holder 34 remains unchanged during pivoting by means of the second pivoting device 40. The gripper 22 has not been shifted in a translational manner by the pivoting process, but has been pivoted about the articulation point 41 relative to the holder 34. In the present case, the radially outermost conductor piece 14 has been bent a second time by pivoting the gripper 22 about the second pivot point 44.

FIG. 6 shows a method according to the invention using six images which each illustrate method steps. In the method shown, an apparatus 10 according to FIG. 1 can be used to move the shown gripper 22 accordingly. First, the gripper 22 is moved from the initial position thereof along the longitudinal direction 20 and the counter-bearing device 28 is moved along the radial direction 18 in the direction of the row 19 of conductor pieces 14 (indicated by an arrow in each case). The (radially inner) clamping jaw 25 of the gripper 22 that faces the row 19 of conductor pieces 14 is moved between the radially outermost conductor piece 14 and the adjacent (radially inwardly arranged) conductor piece 14, such that a gap is produced between the two conductor pieces 14. In the present case, the radially outermost conductor piece 14 is so long that the clamping jaw 25 of the gripper 22 that faces the row 19 of conductor pieces 14 does not contact the adjacent (radially inwardly arranged) conductor piece 14 in the desired (shown in the top center image) gripping position, such that no gap is produced between the two conductor pieces 14. The counter-bearing portion 30 is simultaneously placed against the outermost conductor piece 14 and thus locally fixes the first bending point 32 or the first pivot point 42 of the gripper 22 (top left image).

As soon as the gripper 22 is in the desired gripping position, the conductor piece 14 is gripped in a clamping manner by means of the clamping jaws 25 (indicated by an arrow). For this purpose, the clamping jaw 25 facing away from the row 19 of conductor pieces 14 moves toward the clamping jaw 25 facing the row 19 of conductor pieces 14, which clamping jaw is held in place with respect to the conductor pieces 14. (Top center image). The clamping jaws 25 can also be moved toward one another in a different way.

In this case, the gripper 22 is pivoted about the first bending point 32 or about the first pivot point 42. This is achieved by the holder 34 being pivoted about a pivot point 46 of the holder 36 by means of the first pivoting device 38 (indicated by a curved arrow). This pivot point 46 of the holder lies radially outside the row 19 of conductor pieces 14 and is thus spaced apart from the first pivot point 42 of the gripper 22. The pivot point 46 of the holder 34 is indicated in this case by a cross. During this pivoting process, the actuator 36 is switched into the release mode, such that the gripper 22 can move freely along the gripper longitudinal direction 26. Since the gripper 22 is arranged on the holder 34, the gripper 22 is also pivoted when the holder 34 is pivoted. Due to the clamping, the gripper 22 has a fixed connection to the conductor piece 14 and is therefore also at a fixed distance from the first bending point 32. Due to the fixed distance (since the conductor piece is gripped in a clamping manner and is bent but not “elongated”), the gripper 22 shifts toward the first bending point 32 (indicated by a short arrow in the direction of the first bending point 32) when pivoting. This results in the first pivot point 42 of the gripper 22, which is identical to the first bending point 32 (top right image). This results in a first bend. The pivoting movement of the gripper 22 thus results from a superimposition of the pivoting movement of the holder 34 about the pivot point 46 and the translational movement of the gripper 22 along the longitudinal direction 26 in the direction of the first bending point 32. The first pivot point 42 of the gripper 22 is thus different or spaced apart from the pivot point 46 of the holder 34.

After the first bending, the grip of the gripper 22 is released by the clamping jaws 25 being moved apart (indicated by a short arrow). This is done by moving the clamping jaw 25 which faces away from the row 19 of conductor pieces 14 away from the clamping jaw 25 which faces the row 19 of conductor pieces 14, which clamping jaw is held the position thereof with respect to the row 19 of conductor pieces 14. The gripper 22 is then moved along the now obliquely projecting conductor piece portion or along the gripper longitudinal direction 26 in the direction of the first bending point 32 (indicated by a long arrow) (bottom left image).

As soon as the desired position has been reached, the gripper 22 grips the conductor piece 14 again by means of clamping (indicated by a straight arrow). This gripping also takes place, as described above, by moving the clamping jaw 25 facing away from the row 19 of conductor pieces 14. The gripper 22 is pivoted about a second pivot point 44 (indicated by a curved arrow). In this case, a second bending point 48 is defined by an edge 50 of the clamping jaw 25 of the gripper 22 that faces the row 19 of conductor pieces 14. The second pivot point 44 of the gripper 22 and the second bending point 48 are spaced apart from one another in this case. The second pivot point 44 of the gripper 22 is indicated in this case by a cross. As a result of the pivoting of the gripper 22 about the second pivot point 44 and a fixed distance between the first bending point 32 and the second bending point 48, due to the firm gripping of the conductor piece 14 by means of the gripper 22, a movement is produced during the second pivoting of the gripper 22 that shifts the second bending point 48 in the direction of the stator 12 and radially outward (bottom center image). The second pivot point 44 of the gripper 22 is arranged at a distance from the conductor piece 14.

In particular as a result of the movement of the second bending point 48 in the direction of the stator 12, the conductor piece 14 is bent even further at the first bending point 32, since the counter-bearing portion 30 still bears against the conductor piece 14 and thus fixes the conductor piece at the first bending point 32. Such further bending at the first bending point 32 has to be taken into account in the overall bending process. Springback of the conductor piece material can be taken into account during the bending process, i.e. the conductor piece is bent slightly further than the end position which is actually desired. This means that, when the entire process is finished, the clamping grip on the conductor piece 14 can be released and the conductor piece 14 springs back slightly, as a result of which it finally reaches the actually desired bending position. That is to say, for example, the bending is carried out by greater angle than desired. Springback can thus be compensated for in advance. Such an overbending can of course also be taken into account at the second bending point 48 by the gripper 22 being pivoted by a greater angle than desired during the second pivoting.

After the second bending, the clamping grip of the gripper 22 is released again by the clamping jaws 25 being moved apart again, as described above (indicated in the image by a short arrow pointing to the right). The gripper 22 is moved away from the conductor piece 14 along the longitudinal direction 20 (indicated in the image by a long upward arrow). This can also be achieved by at least partially moving the stator 12 along the longitudinal direction 20 together with conductor pieces 14. The counter-bearing device 28 is also moved away from the conductor piece 14 (indicated in the image by a long arrow pointing to the right).

FIG. 7 is a plan view of a further apparatus 10 according to the invention having a plurality of shaping units 11 according to FIG. 1. Due to the narrow construction of the shaping units 11, a large number of the shaping units 11 can be arranged radially around the stator core 12. An arrangement having six shaping units 11 is shown in FIG. 7. A simultaneous expansion of six conductor pieces 14 is thus possible. In the present case, the conductor pieces 14 are arranged in rows 19 extending in the radial direction 18 on a plurality of circular paths 17 extending in the circumferential direction 16. FIG. 7 shows the state of the apparatus 10 after twisting. In this case, the conductor pieces 14 have already been expanded. Depending on the circumstances, the available installation space can thus be optimally used. The space between the shown shaping units 11 can be used, for example, by an arrangement of further machines and/or tools.

It is also conceivable to arrange the shaping units 11 such that the innermost conductor piece 14 in a row 19 of conductor pieces 14 is expanded inward in the radial direction. In this case, too, a plurality of shaping units 11 can be arranged radially around the stator core 12 in a space-saving manner, due to the compact and, in particular, narrow design thereof.

1. Apparatus for shaping one or more conductor pieces arranged in a stator core, the conductor piece being a hairpin having two elongate legs and a connection portion connecting these two legs,
a large number of conductor pieces being arranged in the stator core, which conductor pieces are arranged in rows extending in a radial direction on a plurality of circular paths extending in a circumferential direction,
the shaping taking place in a free end of the conductor piece that projects from the stator core,
the apparatus comprising:
a receptacle for the stator core in an intended processing position in which the conductor pieces to be shaped are arranged in an initial configuration such that the conductor pieces projecting from the stator core project from the stator core so as to extend along a longitudinal direction, a shaping unit which comprises a gripper which is designed to releasably grip the conductor piece to be shaped between at least two clamping elements in a clamping manner,
characterized in that
the gripper can be moved in the apparatus along a gripper longitudinal direction which extends in parallel with the longitudinal direction when the gripper is in an initial state, the gripper also being pivotable in the apparatus in a plane spanned by the longitudinal direction and the radial direction such that the gripper longitudinal direction is inclined relative to the longitudinal direction in the pivoted state,
the apparatus comprising a counter-bearing device which is movably arranged such that a counter-bearing portion can be placed against the conductor piece in order to define a first bending point.

2. Apparatus according to claim 1, characterized in that the shaping unit comprises an actuator, and the gripper is translationally movable along the gripper longitudinal direction by means of the actuator, it being possible for the actuator to be switched into a release mode in which the gripper can be freely moved in a translational manner along the gripper longitudinal direction.

3. Apparatus according to claim 1, characterized in that the shaping unit comprises a first pivoting device which is arranged and designed to move the gripper on a circular path about a first pivot point, and
a second pivoting device which is arranged and designed to pivot the gripper on a circular path about a second pivot point.

4. Apparatus according to claim 2, characterized in that the actuator and the first pivoting device and/or the second pivoting device are arranged substantially in one plane.

5. Apparatus according to claim 1, characterized in that the clamping elements can be moved relative to one another in a clamping direction orthogonal to the gripper longitudinal direction in order to carry out the clamping process.

6. Apparatus according to claim 1, characterized in that the clamping elements are clamping jaws which extend longitudinally along the gripper longitudinal direction.

7. Apparatus according to claim 1, characterized in that the counter-bearing portion can be placed against the conductor piece by a radially inward movement of the counter-bearing device.

8. Apparatus according to claim 1, characterized in that the counter-bearing portion is arranged such that, in a region of the conductor piece that is directly adjacent to the stator core, said portion can be placed against the conductor piece, the counter-bearing device contacting the stator core from radially outside and/or in the longitudinal direction on the sides of the projecting conductor pieces when the counter-bearing portion bears against the conductor piece.

9. Apparatus according to claim 1, characterized in that the counter-bearing portion has a rounded shape at least in part.

10. Method for shaping one or more conductor pieces arranged in a stator core, the conductor piece being a hairpin having two elongate legs and a connection portion connecting these two legs,
a large number of conductor pieces being arranged in the stator core, which conductor pieces are arranged in rows extending in a radial direction on a plurality of circular paths extending in a circumferential direction, wherein the shaping takes place in a free end of the conductor piece that projects from the stator core,
wherein the method comprises the following steps:
moving a gripper along a longitudinal direction into a gripping position and gripping the conductor piece to be shaped in a clamping manner by means of the gripper;
placing a counter-bearing portion against the conductor piece in order to define a first bending point;
pivoting the gripper on a circular path about a first pivot point, which corresponds to the first bending point and lies in the conductor piece or directly on the conductor piece, in order to cause a first bending of the conductor piece, wherein the pivoting movement of the gripper on the circular path takes place by a holder of the gripper pivoting about a pivot point which lies outside the conductor piece, wherein a translational movement of the gripper relative to the holder is superimposed on this pivoting of the holder, which translational movement is caused by the gripping of the conductor piece and a free translational mobility of the gripper relative to the holder during the pivoting thereof;
releasing the clamping grip of the gripper and moving the gripper along the extension of the conductor piece and gripping the conductor piece again;
pivoting the gripper about a second pivot point, which is arranged at a distance from the conductor piece, in order to cause a second bending of the conductor piece about a second bending point, wherein an edge of the gripper defines the second bending point, wherein during this pivoting process the relative position changes as a result of the gripper pivoting relative to the holder.

11. Method according to claim 10, characterized in that during the pivoting about the second pivot point of the gripper, the second bending point is moved relative to the stator core, radially outward and along the longitudinal direction toward the stator core.

12. Method according to claim 10, characterized in that the shaped conductor piece is the radially outermost of the conductor pieces in a row of conductor pieces extending in the radial direction.

13. Method according to claim 10, characterized in that the first bending point, the second bending point and the second pivot point of the gripper lie in a plane which is spanned by the longitudinal direction and radial direction.

14. Method according to claim 10, characterized in that the first and the second bend extend in one plane.

15. Method according to claim 10, characterized in that the bending at the first bending point and/or at the second bending point is carried out to a greater angle than desired, such that springback of the conductor piece is at least partially compensated for.

16. (canceled)
